(19) United States
(12) Patent Application Publication
(10) Pub. No.: US 2011/0286018 A1
(43) Pub. Date: Nov. 24, 2011

(54) IMAGE FORMING APPARATUS, CONTROL METHOD THEREOF, AND STORAGE MEDIUM

(75) Inventor: Asako Hashizume, Tokyo (JP)

(73) Assignee: CANON KABUSHIKI KAISHA, Tokyo (JP)

(21) Appl. No.: 13/108,679

(22) Filed: May 16, 2011

(30) Foreign Application Priority Data
May 20, 2010 (JP) 2010-116397

(51) Int. Cl. H04N 1/60

(52) U.S. Cl. 358/1.9

(57) ABSTRACT

An image forming apparatus capable of outputting an image using a plurality of coloring agents includes a printing unit configured to print patch data to be used for correction of image data to be output by the image forming apparatus using the plurality of coloring agents, a selection unit configured to select a color corresponding to a coloring agent to be used in printing by the printing unit from the plurality of coloring agents, and a change unit configured to change an arrangement of a pattern of patch data which is printed using the coloring agent of the color selected by the selection unit to an arrangement different from an arrangement of a pattern of patch data to be formed using the selected coloring agent in patch data to be printed using the plurality of coloring agents when the patch data is printed by the printing unit.

### BACKGROUND OF THE INVENTION

1. Field of the Invention

The present invention relates to a gradation correction technique in an image forming apparatus.

2. Description of the Related Art

An image forming apparatus for generating a color output image using coloring agents such as a plurality of types of toners and inks generally executes gradation correction for each color corresponding to a coloring agent in order to maintain a constant output density of each color. Accordingly, the apparatus can constantly output the set density at an arbitrary digital signal value when printing using one color among a plurality of types of coloring agents.

On the other hand, since a patch for correction (gradation) is formed with using the coloring agents for the gradation correction, the coloring agents are consumed. Thus, the image forming apparatus needs to save a certain amount of the coloring agents before the gradation correction. If the amount of the coloring agents is insufficient, highly precision gradation correction cannot be executed. Further, even if the gradation correction is executed, the coloring agents are consumed, and hence if toner shortage is caused at the time of output of print data after the gradation correction, it is meaningless to execute the gradation correction.

Accordingly, a method is discussed in which a remaining quantity of a coloring agent is detected and gradation correction is executed using only a coloring agent which is determined as sufficiently remained. The gradation correction is executed after the remaining quantity of each coloring agent is detected. Thus, the shortage of toners may not occur after the gradation correction and correction can be executed for a color which is normally output (Japanese Patent Application Laid-Open No. 2004-38048).

In recent years, even in an image forming apparatus for generating a color output image as described above, it is not unusual that the use of the image forming apparatus is restricted from the viewpoint of cost cutting and security. For example, if the image forming apparatus is restricted to use only a function of monochrome output, it would be sufficient to correct only one black color in the gradation correction. However, according to Japanese Patent Application Laid-Open No. 2004-38048, a color, the coloring agent of which remains, is always corrected. For example, a color other than black such as cyan and magenta are corrected. Or, if the image forming apparatus is not restricted to the monochrome output, and when normal full color output cannot be executed since other colors are already consumed, correction may be executed with consuming the coloring agents.

Further, the method described in Japanese Patent Application Laid-Open No. 2004-38048 cannot control so as not to execute gradation correction using coloring agents other than the selected coloring agent. According, when the coloring agent to be corrected is reduced, a method for efficiently executing correction or a measure to precisely execute correction is not provided with respect to a color to be selectively corrected.

### SUMMARY OF THE INVENTION

The present invention is directed to a method capable of selectively correcting a color necessary for correction and a technique capable of creating patch data that can change efficiency and precision according to the conditions of an image forming apparatus (e.g., a remaining quantity of toner, use restriction, and a user setting) when selective correction is executed.

According to an aspect of the present invention, an image forming apparatus capable of outputting an image using a plurality of coloring agents includes a printing unit configured to print patch data to be used for correction of image data to be output by the image forming apparatus using the plurality of coloring agents, a selection unit configured to select a color corresponding to a coloring agent to be used in printing by the printing unit from the plurality of coloring agents, and a change unit configured to change an arrangement of a pattern of patch data which is printed using the coloring agent of the color selected by the selection unit to an arrangement different from an arrangement of a pattern of patch data to be formed using the selected coloring agent in patch data to be printed using the plurality of coloring agents when the patch data is printed by the printing unit.

According to the present invention, in addition to the gradation correction in consideration of the conditions of the image forming apparatus (e.g., remaining quantity of toner, use restriction, and user setting), the patch data for the gradation correction can be created according to the use situation of a user and precision to be required.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an image forming apparatus according to a first exemplary embodiment.

FIG. 2 illustrates input and output characteristics of an image forming apparatus.

FIG. 3 is a flowchart illustrating a processing procedure according to the first exemplary embodiment.

FIG. 4 is a flowchart illustrating a selection processing procedure of a color to be corrected.

FIG. 5 is a flowchart illustrating a processing procedure of reconstruction of a patch for correction.

FIGS. 6A to 6D are examples of patches for correction.

FIG. 7 is a flowchart illustrating a processing procedure according to a second exemplary embodiment.

FIGS. 8A and 8B are examples of a user interface (UI) according to the second exemplary embodiment.

FIG. 9 is an example of a UI according to a third exemplary embodiment.

### DESCRIPTION OF THE EMBODIMENTS

Various exemplary embodiments, features, and aspects of the invention will be described in detail below with reference to the drawings.

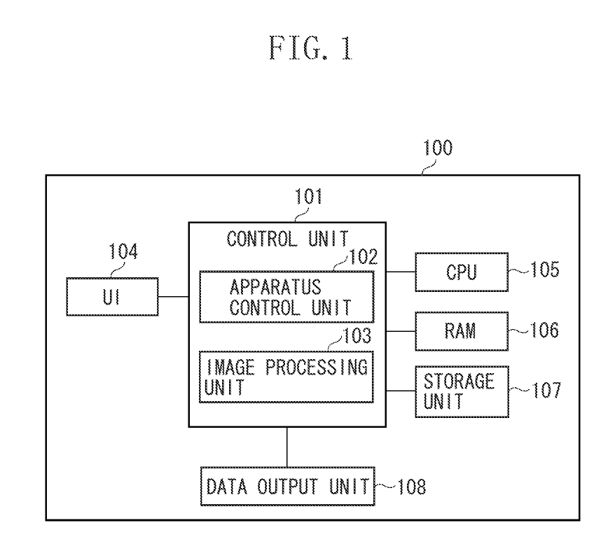

FIG. 1 illustrates a minimum required configuration to realize a first exemplary embodiment.

FIG. 1 illustrates an image forming apparatus 100. A control unit 101 of the image forming apparatus 100 includes an apparatus control unit 102 configured to control the image forming apparatus and an image processing unit 103 configured to optimize image data. The control unit 101 processes image data using a central processing unit (CPU) 105 and a random access memory (RAM) 106, stores the processed image data in a storage unit 107, and outputs an image via a data output unit 108.

The control unit 101 is notified of various settings from a user interface (UI) 104. The image processing unit 103 processes image data based on the notified settings. Alternately, a value set in the UI 104 is stored in the storage unit 107 via the apparatus control unit 102. The image processing unit 103 reads the stored set value to process image data. The data output unit 108 outputs the image data processed in the control unit 101 to a recording device such as a printer and a monitor. The storage unit 107 stores a parameter to control the apparatus, an application to realize the present exemplary embodiment, an operating system (OS), and the like.

The minimum required configuration of the image forming apparatus 100 is as described above. As required, a data input unit such as a network interface and a scanner, a personal computer (PC) to be connected to the image forming apparatus, and the like may also be added. Further, any configuration can be added, if it is necessary when the whole image forming apparatus is considered.

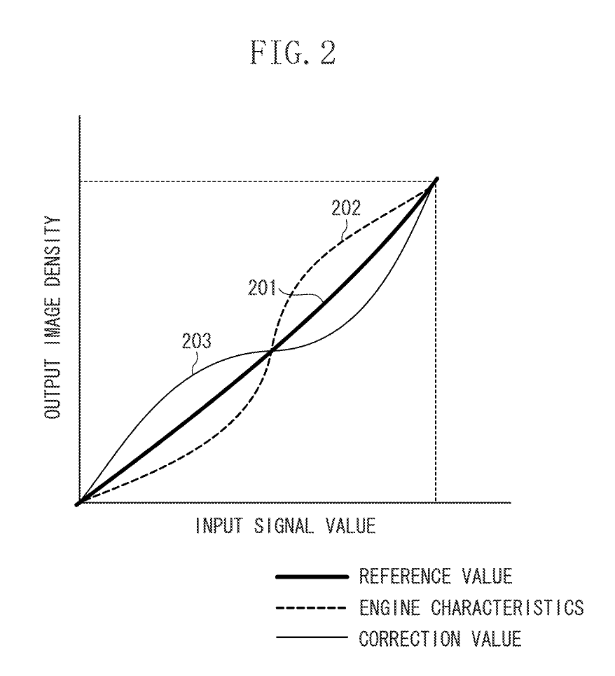

Gradation correction processing will briefly be described referring to FIG. 2. In FIG. 2, output to a sheet of paper will be described as an example. FIG. 2 illustrates a relationship between an input signal value to the image processing unit 103 of the image forming apparatus 100 and an output image density therefrom (input and output characteristics). Input and output signal values are pieces of digital data of 0 to 255, for example, when precision is 8 bits. The output image density is data obtained by measuring an output substance with a density meter.

A reference value 201, which is indicated with a bold line in FIG. 2, represents ideal input and output characteristics of the image forming apparatus. On the other hand, an engine characteristic 202, which is indicated with a dotted line in FIG. 2, is data obtained by measuring the density of the output substance which is output when an input signal value to the image processing unit 103 is served as an output signal value as it is. The engine characteristics are always accompanied by some fluctuations due to environments or conditions that the image forming apparatus is placed. Accordingly, a correction value 203, which is indicated with a thin solid line in FIG. 2, is generated to fit the input and output characteristics to the reference value 201. The correction value is necessary to correct the input signal value to realize the input and output characteristics close to the reference value. The correction value is used in a lookup table for one-dimensional gradation correction which expresses a one-to-one relationship between the input signal value and the output signal value.

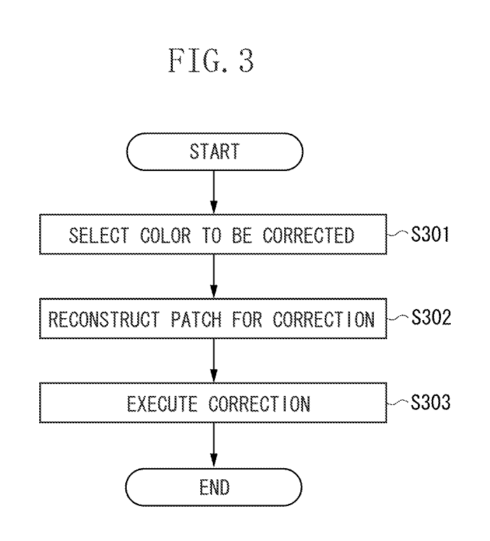

FIG. 3 is a flowchart illustrating a processing flow according to the present exemplary embodiment. A control program (not illustrated) by which the present exemplary embodiment is realized is stored in the storage unit 107, downloaded in the RAM 106, and executed by the CPU 105. In FIG. 3, the gradation correction of the image forming apparatus 100 that includes toners of cyan, magenta, yellow, and black (CMYK) as coloring agents will be described as an example.

Similarly to the description above, a method of gradation correction will be described such that a lookup table is generated (corrected) based on FIG. 2 using the result of outputting a patch of a primary color (single color of C, M, Y, and K) on a sheet of paper to execute color measurement, and print data is corrected using the lookup table. However, a method for forming a patch inside the image forming apparatus (an intermediate transfer member or a photosensitive member in the apparatus) without outputting on the sheet, and generating the lookup table by measuring the patch with an internal sensor arranged in the vicinity of the intermediate transfer member or the photosensitive member may also be adopted.

First, in step S301, a color to be corrected for executing the degradation correction is selected. When the color to be corrected is selected, the following selection method is considered.

From the viewpoint of cost cutting and security, even in a color image forming apparatus, if the use of the apparatus is restricted, and only monochrome print is executed, only K may be served as the color to be corrected. In addition, an operation method such that even a user without administrator authority in a division management system can correct at least only K can be considered.

Further, if the color image forming apparatus is in the use permission state, in which use restriction is not provided, and the remaining quantity of some toners are not sufficient but other color toners remains, monochrome print or two color print can be performed using the coloring agent of the color toner which remains. In this case, only the lookup table for gradation correction corresponding to the remaining color toner or the color to be used in printing is corrected, and the sufficient processing can be performed. Accordingly, a method such that only the selected color is selected as a color to be corrected is also considered.

First, in step S301 the color to be corrected is selected using such a selection method of the color to be corrected.

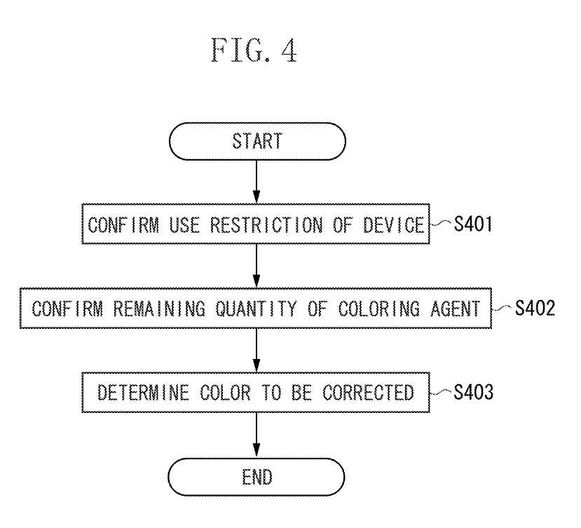

The selection method of the color to be corrected is illustrated in FIG. 4 in detail. First, in step S401, the use restriction of the image forming apparatus is confirmed. The confirmation is made to eliminate a color which cannot be used due to the use restriction if the lookup table for the gradation correction is generated from a target of correction.

Next, in step S402, the remaining quantity of the coloring agent is confirmed. The remaining quantity of the coloring agent of each color of CMYK is confirmed, and the coloring agent whose remaining quantity is less than a predetermined quantity (threshold value) is eliminated from the target of correction. This is because if the coloring agent immediately runs out in spite of the correction, the effect of the correction is little. Further, by executing correction, the coloring agent is further decreased.

In step S403, the color to be corrected is determined based on the results of confirming the use restriction of the image forming apparatus and the remaining quantity of the coloring agent.

The predetermined quantity can be determined by a total quantity of the toner quantity necessary for the gradation correction and an average toner quantity to be used in subsequent printing processing. The “average toner quantity to be used in the subsequent printing processing” refers to, for example, a toner quantity to be consumed per a day.

The average toner quantity to be used in the subsequent printing processing can be determined by dividing consumption during some fixed period (e.g., one month) after a new toner cartridge is installed in the apparatus by the number of days. A toner quantity to be consumed during not one day but an arbitrary period may also be calculated beforehand, and this toner quantity can be used as the “average toner quantity to be used in the subsequent printing processing”. Further, a user can also set an arbitrary quantity as the predetermined quantity (threshold value) beforehand.

Confirmation of the use restriction of the image forming apparatus is preset to each user who logs in the apparatus.

In step S302, a patch pattern that is a pattern when a patch for correction is printed on a print sheet is reconstructed.

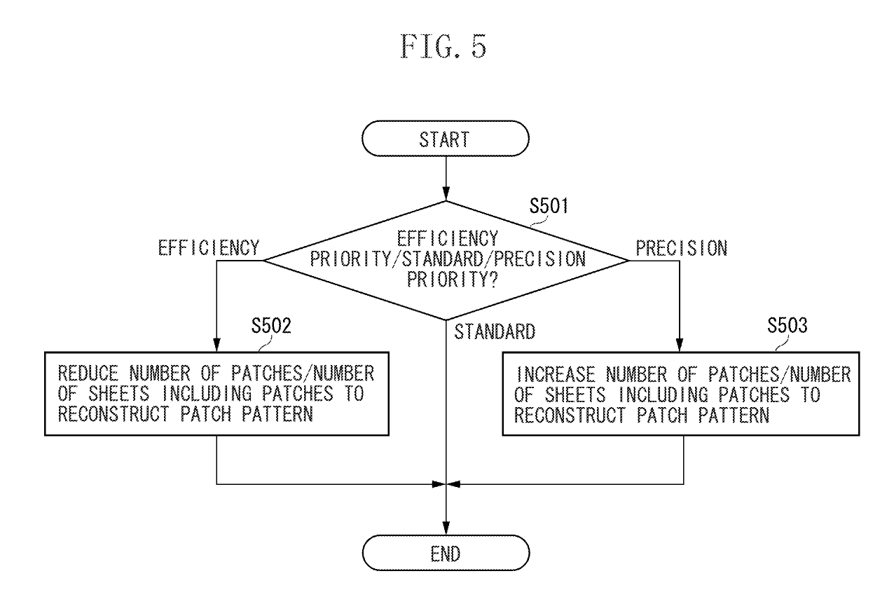

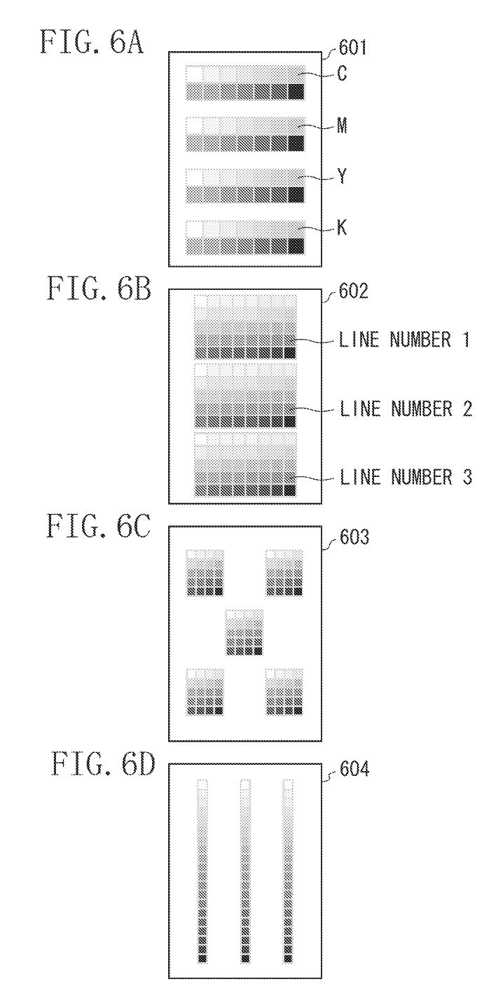

Referring to FIGS. 5 and 6A to 6D, a case where the color to be corrected is only K will be described in detail as an example. In the gradation correction in the present exemplary embodiment, the color to be corrected is restricted, so that a patch printable area to K is increased more than that in a case where all colors are corrected. Thus, in step S302, the patch pattern is reconstructed by changing a patch arrangement and the number of patches corresponding to a setting. FIG. 6A illustrates a patch of normal degradation correction and all colors are stored in one sheet.

In step S501, first, when a patch pattern is reconstructed, the processing is switched based on the setting for what is prioritized. In step S501, three cases, i.e. efficiency priority, standard, and precision priority, are considered.

If the efficiency priority is selected (EFFICIENCY in step S501), then in step S502, as illustrated in FIG. 6B, patches different in a intermediate processing method during image formation are gathered into one sheet, so that paper and time to be consumed can be saved and correction can be efficiently executed. More specifically, patches for the degradation correction which are used for image formation that is different in the number of lines and are normally printed and output on a plurality of sheets (e.g., low number of lines 1, low number of lines 2, and high number of lines) can be printed on one sheet or the number of sheets fewer than the normal.

Further, the number of patches is reduced to some extent to reconstruct a patch pattern. After the number of patches is reduced, various types of image formation may further be gathered into one sheet. Thus, the toner quantity to be consumed is reduced and hence more efficient correction can be executed. However, of course the number of patches without losing correction precision is required.

In step S501, if the precision priority is selected (PRECISION in step S501), then in step S503, the number of patches is increased and a patch pattern is reconstructed. Other than this reconstruction method, patches are arranged in a plurality of places in consideration of in-plane unevenness to reconstruct the pattern. For example, as illustrated in FIG. 6C, the same patch is disposed in a different area in the printable area in consideration of unevenness of the whole in-plane (main scanning unevenness). Further, as illustrated in FIG. 6D, the same patch data is arranged in consideration of unevenness in a short direction. Thus, highly precision correction can be executed.

In step S501, if the standard is selected (STANDARD in step S501), the patch pattern is not reconstructed. When all colors are the color to be corrected, the standard is selected in the reconstruction of the patch pattern for correction, and normal degradation correction can be executed. A setting according to processing flow illustrated in FIG. 5 can also be set by a user in advance. As described above, when the type of the patch for correction is determined, finally, in step S303, the degradation correction is executed using the patch for correction whose pattern is reconstructed in step S302.

In the degradation correction, the patch data for correction is printed, and the image forming apparatus reads the printed patch data. Thus, the lookup table can be generated (corrected) using the result of reading.

Then, print data to be output by the image forming apparatus is corrected using the generated lookup table. The lookup table is periodically generated (updated). The image forming apparatus is corrected so as to maintain constant output characteristics using the lookup table.

As described above, the gradation correction is executed by restricting the color to be corrected according to the remaining quantity of the toner in the image forming apparatus, so that execution of unnecessary degradation correction can be avoided and useless consumption of the toner can be reduced. Further, in the case where the division management system tends to restrict a function or the like, the degradation correction which flexibly corresponds to correct the restricted color can be executed. Furthermore, the patch pattern for correction is reconstructed based on a mode at the time of correction, so that the precision and efficiency of correction can be improved, and low-cost degradation correction saving the sheet of paper or a coloring agent can be executed.

In a second exemplary embodiment, only a portion different from the above-described first exemplary embodiment will be described. In the present exemplary embodiment, unlike the first exemplary embodiment, a color to be corrected is not automatically selected in the image forming apparatus but is determined in response to the selection by a user.

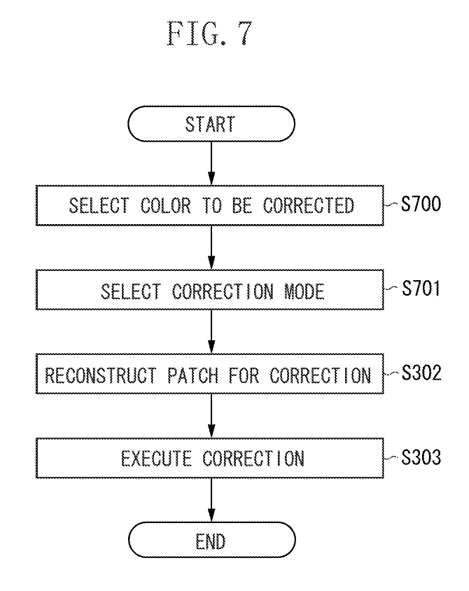

FIG. 7 illustrates a processing flow according to the present exemplary embodiment. Similarly to FIG. 3, control program (not illustrated) by which the present exemplary embodiment is realized is stored in the storage unit 107, downloaded in the RAM 106, and executed by the CPU 105. First, in step S700, a color to be corrected is selected. Selection of the color to be corrected in the present exemplary embodiment in step S700 is instructed by a user via the UI 104 on the image forming apparatus 100. Then, in step S701, a correction mode is selected. The user instructs the selection of the correction mode via the UI 104 similarly to the selection of the color to be corrected in step S301 illustrated in FIG. 3.

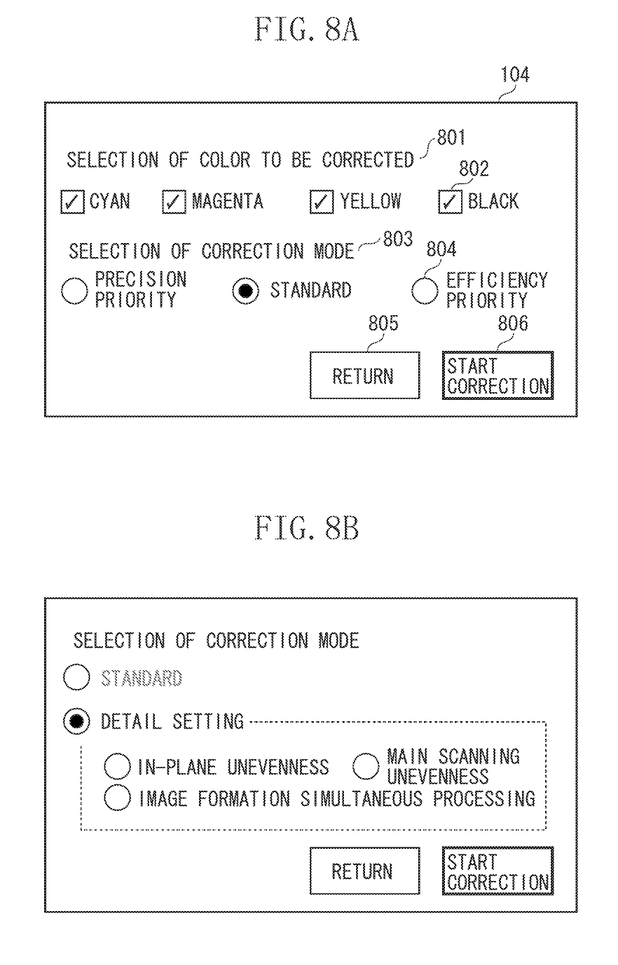

An example of the UI 104 is illustrated in FIG. 8A. The UI 104 includes at least a UI 801 for selecting the color to be corrected in step S700 and a UI 803 for selecting the correction mode in step S701 illustrated in FIG. 7. For omission of description, the UI 801 for selecting the color to be corrected and the UI 803 for selecting the correction mode are illustrated on the same screen. However, these UI may be set on the different screens. The UI 801 for selecting the color to be corrected displays the colors of the coloring agents which are possessed by the image forming apparatus 100. Accordingly, the user checks into a checkbox indicated in front of the display of each color, and can select the color. Thus, since the US 104 includes a UI 802 capable of selecting for each color, a user can select not only a single color but also a plurality of colors at the same time.

In FIG. 8A, the checkboxes are illustrated as an example. However, a selection method is not limited to the checkbox. The UI 803 for selecting the correction mode allows the user to select anyone of the efficiency priority, the standard, and the precision priority. In FIG. 8A, radio buttons are illustrated as an example. However, a selection method is not limited to the radio button. For example, as illustrated in FIG. 8B, a form may be adopted in which either of the standard and the detail setting is selected and further an item can be selected in the detail setting. Further, the names and types of the correction mode are not limited to the above examples. The UI 104 further includes a return button 805 for cancelling processing and a correction start button 806 for executing reconstruction of the patch pattern for correction in step S302 with the set values.

When all colors are selected in the UI 801 for selecting the color to be corrected, since the efficiency priority cannot be realized, it is needed to control the UI 803 for selecting the correction mode in association with the number of colors such that the color may be grayed out from the selection of the correction mode.

In step S302 in FIG. 7, the reconstruction of the patch pattern for correction is executed according to the set values (the settings of the selection color and the mode) in the UI 104 as illustrated in FIG. 8A. Finally, in step S303 in FIG. 7, the correction mode is selected via the UI illustrated in FIG. 8B in step S302, and the gradation correction of the image forming apparatus is executed using the patch for correction which is set according to the selected correction mode and is reconstructed with the pattern.

As described above, the gradation correction is executed after the color to be corrected and the correction mode are specified via the UI 104, so that only a color necessary for the user can be corrected with required precision. Accordingly, execution of excess gradation correction can be avoided. A recommended value can be set as a default to the UI 104. Accordingly, the user does not need to feel inconvenience of setting and the setting can flexibly be changed as required.

The default recommended value can be determined based on the use settings of the apparatus that an administrator intends to use. Further, it may be displayed such that which color in the apparatus is most frequently used (emphasized) during output is detected and cause the detected color to be selected on the UI by default.

In a third exemplary embodiment, only a portion different from the second exemplary embodiment in the selection of the color to be corrected in step S700 and the selection of the correction mode in step S701 in the second exemplary embodiment will be described.

In the present exemplary embodiment, unlike the second exemplary embodiment, display is executed in view of a state of the image forming apparatus in display of the UI 104. More specifically, in step S700 illustrated in FIG. 7, when a user displays the UI 801 to select the color to be corrected, the results of confirming the use restriction of the image forming apparatus in step S401 and confirming the remaining quantity of the coloring agent in step S402 described in the first exemplary embodiment are reflected.

For example, the color which is automatically determined that the remaining quantity of the coloring agent thereof is small is grayed out on the UI and is eliminated from the target of selection. Similarly, if there is the restriction of the division management system, in the UI 803 for selecting the correction mode for executing the selection of the correction mode in step S701, the display on the UI is changed according to the restriction. For example, if there is a color whose remaining quantity of the coloring agent is small, the restriction such that precision priority is eliminated from the target of selection is provided. Determination of the remaining quantity of the coloring agent is described as in the first exemplary embodiment.

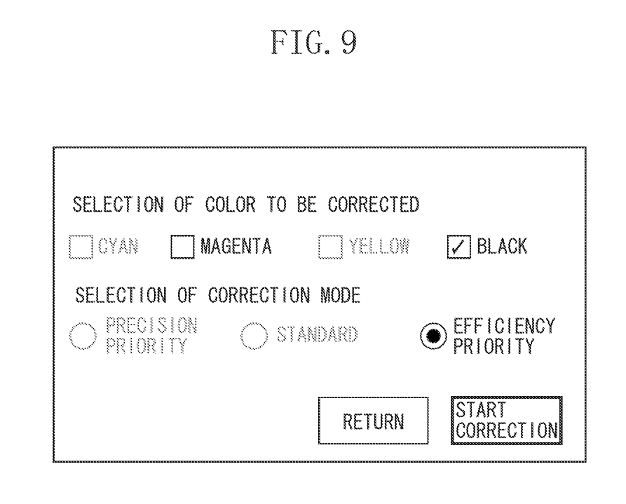

FIG. 9 illustrates an example of the UI 104 in the image forming apparatus 100 in which the use is restricted. It is assumed that the division management system is introduced into a certain image forming apparatus 100 and use of a general user is permitted only monochrome or two color print/copy/gradation correction of magenta. At this time, when the general user logs in and uses the image forming apparatus, selectable color are only M and K, and a mode can be selected is only the efficiency priority. Other choices are grayed out as illustrated in FIG. 9. Thus, the UI 104 executes display that does not allow the user's free selection. On the other hand, when an administrator logs in and uses the image forming apparatus, all selections are possible.

As described above, a state of the image forming apparatus (a user who logs in the apparatus, the use restriction, and the remaining quantity of the coloring agent) is automatically detected and reflected in the UI 104, so that the gradation correction corresponding to various environmental conditions and high in flexibility can be executed. Further, the gradation correction to which a user unconsciously exhibits maximum performance can be realized.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-116397 filed May 20, 2010, which is hereby incorporated by reference herein in its entirety.

What is claimed is:

1. An image forming apparatus capable of outputting an image using a plurality of coloring agents, the image forming apparatus comprising:
a printing unit configured to print patch data to be used for correction of image data to be output by the image forming apparatus using the plurality of coloring agents;
a selection unit configured to select a color corresponding to a coloring agent to be used in printing by the printing unit from the plurality of coloring agents; and
a change unit configured to change an arrangement of a pattern of patch data which is printed using the coloring agent of the color selected by the selection unit to an arrangement different from an arrangement of a pattern of patch data to be formed using the selected coloring agent in patch data to be printed using the plurality of coloring agents when the patch data is printed by the printing unit.

2. The image forming apparatus according to claim 1, wherein the selection unit selects a color corresponding to a coloring agent which is set as permitted to be used among the plurality of coloring agents to be used by the image forming apparatus.

3. The image forming apparatus according to claim 1, wherein the selection unit detects a remaining quantity of the plurality of coloring agents included in the image forming apparatus, and if it is detected that the remaining quantity of the coloring agent is more than a threshold value, the selection unit selects a color corresponding to the coloring agent.

4. The image forming apparatus according to claim 1, wherein the change unit changes the pattern of the patch data by selecting efficiency priority of the correction or precision priority of the correction.

5. The image forming apparatus according to claim 4, wherein if the efficiency priority is selected by the change unit, an arrangement position of the patch pattern which is printed using the coloring agent selected by the selection unit is changed so as to reduce the number of patches compared with a case in which correction is executed using the patch data printed using the plurality of coloring agents printed by the printing unit and/or so as to reduce sheets to be used in printing compared with a case in which correction is executed using the plurality of coloring agents.

6. The image forming apparatus according to claim 4, wherein if the precision priority is selected by the change unit, an arrangement position of the patch pattern which is printed using the coloring agent selected by the selection unit is changed so as to increase the number of patches compared with a case in which correction is executed using the patch data printed using the plurality of coloring agents printed by the printing unit and/or so as to increase a printable area of the patch in a sheet to be used in printing.

7. The image forming apparatus according to claim 4, wherein if both of the efficiency priority and the precision priority are not selected by the change unit, the change unit is not executed and correction is executed using the plurality of coloring agents.

8. The image forming apparatus according to claim 1, further comprising an interface unit configured to receive an instruction from a user,
wherein the selection unit selects a color specified by the user via the interface unit.

9. The image forming apparatus according to claim 1, further comprising an interface unit configured to receive an instruction from a user,
wherein the change unit changes to a patch pattern specified by the user via the interface unit.

10. The image forming apparatus according to claim 1, further comprising an interface unit configured to receive an instruction from a user,
wherein the selection unit detects a remaining quantity of each color agent and controls a display in the interface unit in order to prompt the user to select a color to be corrected from a color corresponding to the coloring agent detected that the remaining quantity thereof is more than a threshold value and a color which is permitted to be used beforehand in the image forming apparatus.

11. The image forming apparatus according to claim 1, further comprising an interface unit configured to receive an instruction from a user,
wherein the change unit controls a display in the interface unit in order to prompt the user to select a patch pattern to be used in correction from patch patterns which are set beforehand in the image forming apparatus.

12. A method for controlling an image forming apparatus capable of outputting an image using a plurality of coloring agents, the method comprising:
printing patch data to be used in correction of image data to be output by the image forming apparatus using the plurality of coloring agents;
selecting a color corresponding to a coloring agent to be used in printing from the plurality of coloring agents; and
changing an arrangement of the patch data which is printed using the coloring agent of the selected color to an arrangement different from an arrangement of a pattern of patch data to be formed using the selected coloring agent in patch data to be printed using the plurality of coloring agents when the patch data is printed.

13. The method according to claim 12 further comprising selecting a color corresponding to a coloring agent which is set as permitted to be used among the plurality of coloring agents to be used by the image forming apparatus.

14. The method according to claim 12 further comprising:
detecting a remaining quantity of the plurality of coloring agents included in the image forming apparatus; and
selecting, if it is detected that the remaining quantity of a coloring agent is larger than a threshold value, the color corresponding to the coloring agent.

15. The method according to claim 12 further comprising changing a pattern of patch data by selecting efficiency priority of the correction or precision priority of the correction.

16. The method according to claim 15 further comprising, if the efficiency priority is selected, changing an arrangement position of a patch pattern which is printed using the selected coloring agent so as to reduce the number of patches compared with a case in which correction is executed using the patch data printed using the plurality of coloring agents printed and/or so as to reduce sheets to be used in printing compared with a case in which correction is executed using the plurality of coloring agents.

17. The method according to claim 15 further comprising, if the precision priority is selected, changing an arrangement position of a patch pattern which is printed using the selected coloring agent so as to increase the number of patch compared with a case in which correction is executed using the patch data printed using the plurality of coloring agents printed and/or to increase a printable area of the patch in a sheet to be used in printing.

18. The method according to claim 15 further comprising, if both of the efficiency priority and the precision priority are not selected, performing correction using the plurality of coloring agents without executing a change.

19. The method according to claim 12,
wherein the image forming apparatus includes an interface unit configured to receive an instruction from a user, and
the method further comprising selecting a color specified by the user via the interface unit.

20. The method according to claim 12,
wherein the image forming apparatus includes an interface unit configured to receive an instruction from a user, and
the method further comprising changing to a patch pattern specified by the user via the interface unit.

21. The method according to claim 12,
wherein the image forming apparatus includes an interface unit configured to receive an instruction from a user, and
the method further comprising:
detecting a remaining quantity of each coloring agent; and
controlling a display in the interface unit in order to prompt the user to select a color to be corrected from a color corresponding to the coloring agent detected that the remaining quantity thereof is more than a threshold value and a color which is permitted to be used beforehand in the image forming apparatus.

22. The method according to claim 12,
wherein the image forming apparatus includes an interface unit configured to receive an instruction from a user, and
the method further comprising controlling a display in the interface unit in order to prompt the user to select a patch pattern to be used in correction from patch patterns which are set beforehand in the image forming apparatus.

23. A computer-readable storage medium storing a program to cause a computer to execute a method according to claim 12.
